(19) United States
(12) Patent Application Publication
(10) Pub. No.: US 2014/0335493 A1
(43) Pub. Date: Nov. 13, 2014

(54) TRAINING MANNEQUIN FOR USE IN SPARRING, SELF-DEFENSE, LAW ENFORCEMENT, AND COMBAT SPORTS TRAINING

(71) Applicant: Virtic Industries, LLC, Wayne, PA (US)

(72) Inventors: James R. Iocca, Brookhaven, PA (US); Gary R. Cane, Phoenixville, PA (US); Andres Lebaudy, Wayne, PA (US); Colin P. Ryan, Wayne, PA (US); Thomas A. Kier, Narberth, PA (US)

(73) Assignee: Virtic Industries, LLC, Wayne, PA (US)

(21) Appl. No.: 14/276,182

(22) Filed: May 13, 2014

Related U.S. Application Data
(60) Provisional application No. 61/822,552, filed on May 13, 2013.

(51) Int. Cl. G09B 19/00

(52) U.S. Cl. CPC G09B 19/00
USPC 434/256

(57) ABSTRACT

A humanoid mannequin with jointed, positionable, and realistic reactive limbs. The mannequin is used in connection with sparring, self-defense, law enforcement, and combat sports training. The mannequin is constructed with a jointed endoskeleton frame that permits the mannequin limbs to be positioned in various training postures, and to realistically hold such positions against external forces exerted by a combatant. The mannequin skeleton also includes a series of elastic elements that allow the skeleton to be forced from its preset posture, and to recover that posture once the disturbing force is removed. The mannequin skeleton is covered by a durable flexible elastomer skin filled with a resilient supporting foam. This housing material provides the external anatomical features of a human body as well as the padding required to protect combatant users from the internal rigid skeletal components.

### RELATED APPLICATION

This application claims the benefit of priority to U.S. Provisional Application Ser. No. 61/822,552, filed on May 13, 2013, the contents of which are incorporated into this document by reference.

### TECHNICAL FIELD

The present invention relates generally to training mannequins and, more particularly, to anatomically accurate training mannequins having positionable limbs for use in sparring, self-defense, law enforcement, and combat sports training

### BACKGROUND OF THE INVENTION

Training for combat sports, such as boxing or football, for self-defense, or for law enforcement personnel and security forces is typically accomplished by pairing combatants with human sparring partners or with inanimate surrogates (i.e., training mannequins or dummies). Sparring with a human opponent offers more realism but requires a combatant to substantially scale back their use of force to avoid injuring their partner. Moreover, the number of training repetitions are severely limited as human partners tire after absorbing repetitive physical strikes. Inanimate surrogates by contrast can be engaged with full force and for countless repetitions, but offer varying degrees of combative realism, as such surrogates may or may not look, feel, move, and/or react as a human opponent normally would.

The earliest art in inanimate sparring surrogates took the form of a bag having a simple cylindrical, spherical, or cuboid geometric shape, and formed from an outer shell (typically leather or rawhide) filled with sand or synthetic padding material. These punching bags still remain in widespread use today. An example of such a punching bag, as typically hung from an overhead support with a chain or rope, is disclosed in U.S. Pat. No. 2,156,831. While standard punching bags are useful training aids, they do not look, feel, or move like a human opponent. More specifically, such punching bags do not provide useful visual anatomical references to target and they do not provide lifelike tactile feedback when punched or kicked.

More recent innovations in the art have aimed to address some of these look and feel limitations of traditional punching bags. For example, U.S. Pat. No. 5,971,398 (“the '398 patent”) discloses a life-sized mannequin made of flexible, resilient materials and shaped in the form of a human torso. The torso includes head, shoulder, chest, and abdominal sections, with each including detailed replicas of anatomical features of the human body (e.g., the head section includes a nose, mouth, and ears; the chest section includes pectoral muscles; etc.). In addition to more realistically and visually representing a human opponent, the polymer materials used to form the mannequin also more closely replicate a lifelike feel when struck. Three-dimensional mannequins like those disclosed in the '398 patent do provide a more realistic sparring surrogate to train with, but the absence of arms or legs limits the utility of such apparatus to serving merely as an unprotected striking target, similar to a traditional punching bag.

Effective training in self-defense or combat sports requires that participants learn to maneuver past an opponent's defensive postures as well as to neutralize the opponent's offensive moves. Practicing techniques to clear, block, and/or restrain an opponent's arms and/or legs are highly desirable for the most effective training. Unfortunately, effective training surrogates for this purpose are currently unavailable.

Training dummies for combat sports that incorporate arms and legs in some form have been previously disclosed, but they do not adequately replicate the look, feel, movement, or counter-movement of human limbs. For example, a popular training aid in martial arts is the wooden dummy known as a Mook Yan Jung or Wing Chun dummy. These devices are traditionally made from cylindrical wooden posts having several outwardly extending rigid “arms” and “legs” that bear little resemblance to human limbs. The limbs are typically cylindrical wooden blocks without any padding. They are typically firmly attached to the primary frame member and do not yield or deflect when struck. Mounting arrangements for some Wing Chun dummy embodiments have been disclosed, as for example in U.S. Pat. No. 6,808,477, that allow the wooden dummy to move from side to side and to be more forgiving when struck. While such innovations improve the training value of such a device, the dummy's movement, appearance, and feel remain far from being realistic and human.

Other combat training dummies have been disclosed that more closely resemble the human body and that do include arms and legs. However, each of these devices have their own drawbacks and limitations. For example, U.S. Pat. No. 6,139,328 (“the '328 patent”) discloses a humanoid grappling dummy with arms and legs that may assume a variety of positions. The joints for the '328 patent apparatus are very stiff, “freezing” the limbs into a particular position and requiring a substantive force to displace from the set frozen position. As disclosed in the '328 patent, when a sufficient force is applied, the joint gives way allowing the limb to be moved. However, as the force falls off, the joint “freezes” the limb in the new position. Accordingly, the movement of the limb is unnatural when compared to a real human. Further, there is no mechanism for the limb to automatically return to its original position after a disturbing force is removed. Moreover, the materials used to produce the dummy are not conducive to repetitive striking exercises and do not provide much anatomical detail; that is, the dummy has a general humanoid contour but lacks detailed human features.

Finally, U.S. Pat. No. 6,155,960 (“the '960 patent”) discloses a training dummy assembly in human form that claims to mimic human movements and reactions to forces applied to the dummy by a user. The dummy's arms may be positioned in three distinct fighting stances and are designed to return to their original position after a disturbing force is removed. The dummy is formed with a complex internal skeletal frame structure having elaborate joints. However, the complexity of the design makes it cost prohibitive to realize commercially. More importantly, the '960 patent apparatus only accommodates a very limited number of assumable positions (i.e., three). Further, the skeletal design with concentric chambers, complex joints, and securing bolts results in a large skeletal frame that reduces the interior body volume available for padding. Having less padding available to absorb blows (i.e., having the skeletal frame too close to the surface), increases the probability of there being user injury and/or damage to the mannequin.

### SUMMARY OF THE INVENTION

The present invention provides a humanoid mannequin for use in combat sports, self-defense, or law-enforcement training. Its principal aims are to provide a mannequin (a) with external anatomical accuracy in look and feel, (b) having positionable limbs that realistically mimic human movements and reactions to externally applied forces, and (c) that is cost effective to manufacture. It is also a principal objective of this invention to provide a mannequin with arms that may be positioned in many different fighting poses and that automatically return to their original position after a disturbing force is removed.

It is also an objective of this invention that a user be able to readily position and re-position the mannequin in a desired stance without the use of any tools and within a very short time frame.

It is also an objective of this invention to provide a humanoid training mannequin formed from a polymer covering skin filled with resilient supporting foam material, and reinforced with an internal skeletal structure that collectively more closely replicates the reaction and feel of a human sparring partner. The addition of internally reinforcing skeletal elements disclosed in this invention eliminates the inherent floppiness of prior art training dummies made of resilient foam materials alone.

It is also an objective of this invention to provide a humanoid training mannequin having a mounting system that maintains the training mannequin in an upright position until a user initiates a take-down move, whereupon the mannequin and mounting system automatically disengage from each other such that the user can take the mannequin to the ground and continue to engage it without interference from the mounting system.

It is a further objective of this invention to provide a training mannequin that offers multiple options for mounting the mannequin to a base system. Under one optional mounting arrangement, a live person can comfortably hold and maneuver the mannequin by use of a special-purpose harness so as to provide a more realistic combat scenario for the training subject. The person and mannequin combination serve as a sparring partner, with the person providing intelligence of combat movement and reaction, and the mannequin absorbing the physical strikes from the training subject. Under a second optional mounting arrangement, the mannequin can be suspended from above by attaching a cord to the top of its head, or to its upper back, or to both its head and upper back. Under a third optional mounting arrangement, the mannequin can be suspended from above as described for the second arrangement, and have its legs restrained from below by attaching cords to its feet. Under a fourth optional mounting arrangement, the mannequin can be attached to a wall or other free-standing structure to its rear. Under a fifth optional mounting arrangement, the mannequin can be directly attached to a base structure that rests on the ground or floor.

According to one aspect of the invention, the above objectives are realized in a training mannequin having a composite torso and head component, left and right arm components, and a composite leg pair component. The head/torso component includes a head section, a neck section, an upper trunk section with arm attachment points at its upper left and right sides, creating shoulder elements, and a lower trunk section with a leg pair attachment point at its bottom rear. The left and right arm components are independent and symmetrical and each include an upper arm section, an integral elbow joint, a forearm section, an integral wrist joint, and a hand. The two arm components function independently but identically and attach to the torso's left or right arm attachment points, respectively, to form left and right shoulder joints. The leg pair component includes left and right legs that come together at a hip section. The leg pair component attaches to the torso component at its lower back attachment point, along a spine element.

According to another aspect of the invention, the training mannequin includes left and right shoulder joints that enable the articulation of the corresponding arm component with respect to the torso component, allowing full range of arm motion in three dimensions. Assuming a human person with arms straight and hanging down, a coordinate system centered about the shoulder joint is defined by symmetric roll, pitch, and yaw axes, wherein the roll axis runs longitudinally through the arm from shoulder to hand, the pitch axis runs horizontally across the upper torso from one shoulder to the other, and the yaw axis is perpendicular to both the pitch and roll axes and runs from behind the shoulder to the front. The shoulder joint includes a fastener to attach the upper arm section to the torso arm attachment point of the upper trunk section, and a pivot to allow the arm to rotate 360 degrees about each roll, pitch, and yaw axis. The shoulder joint also includes a lock that holds the joint in any one of a plurality of preset positions, such that the arm can be posed in a wide variety of static positions with respect to the torso. The shoulder joint further includes a resilient element that permits the joint to be temporarily displaced from its fixed position when an external force is applied to the arm, and a restorative element that returns the joint essentially to its preset fixed position after the disturbing force is removed.

According to another aspect of the invention, each arm in the training mannequin includes an integral elbow joint that enables the forearm to articulate along one axis with respect to the upper arm, and a wrist joint that allows the hand to articulate along or about three axes with respect to the forearm. The elbow joint includes a lock that holds the joint in any one of a plurality of positions, and a constraint that limits the permitted range of motion. The elbow and wrist joints further include a resilient element to permit each joint to be temporarily displaced from its resting position by an external force, and a restorative element that returns the joint essentially to its original position when the disturbing force is removed.

According to another embodiment of the invention, the training mannequin has detachable legs that each have joints that enable articulation of the individual legs through a limited range of motion with respect to the torso component. The hip joint includes a fastener to attach the upper leg to the hip and a pivot to allow the leg to rotate approximately 180 degrees with respect to the torso pitch axis. The hip joint also includes a lock that holds the joint in any one of a plurality of preset positions, such that the leg can be posed in a wide variety of static positions with respect to the torso. The hip joint further includes a resilient element that permits the joint to be temporarily displaced from its fixed position when an external force is applied to the leg, and a restorative element that returns the joint essentially to its preset fixed position after the disturbing force is removed.

In a preferred embodiment of the invention, the mannequin torso component is made from a resilient polyurethane elastomer skin shell filled with flexible polyurethane foam material that surrounds an internal skeletal structure consisting of a substantially T-shaped plate. The foam and external skin shell are molded in the form of a human torso and head, with the resulting body shape capturing detailed external anatomical features of the human body. The foam has a density of approximately four pounds per cubic foot resulting in a body interior that is flexible, relatively soft, and resilient such that it initially deforms when struck but always returns essentially to its original shape, and such that it protects the combatant from striking the rigid internal skeletal elements. The polyurethane external skin material formulation results in a smooth texture that looks and feels human; it has a hardness of approximately 60 durometer and provides a surface with a low coefficient of friction that reduces gripping force when struck. The internal T-shaped skeletal plate can be made of metal, plastic, or other rigid polymer material and provides various attachment points to the torso, including arm attachment points at each upper side, a leg attachment point at the bottom, and multiple optional attachment points at the rear. In an alternate embodiment of the invention, a void is created in the central lower rear section of the mannequin torso, such that the rigid skeletal plate and its optional attachment points are accessible. The optional attachment points may be used to fasten the mannequin to an external mounting system, or to mount other equipment directly to the mannequin, such as, for example, sensing, computing, and/or communication instruments which may be used to measure forces imparted or other training metrics, weight bags which may be used to vary the mass of the mannequin, and other similar elements.

In another embodiment of the invention, a flexible strap is attached to the skeletal frame of the mannequin torso and arranged within the torso interior to provide additional structural support for the otherwise pliable foam material. The strap runs vertically upward from its attachment point at the top of the spine plate through the neck, and into the top of the head. The upper strap segment provides structural rigidity to the neck and head sections, which would otherwise react to a combatant's strike with unrealistic floppiness. The upper end of the strap includes a special attachment that remains interior to the head but is externally accessible; the attachment allows optional equipment to be mounted in the head and also enables the mannequin to be suspended from above. In an alternate embodiment of the invention, the upper strap portion protrudes out from the top of the head and includes an integral loop that can be used to suspend the mannequin from above.

In a further preferred embodiment of the invention, each mannequin arm component is also made from a resilient polyurethane elastomer skin shell filled with flexible polyurethane foam material that surrounds an internal skeletal structure primarily consisting of a humerus segment and a radius segment made of, for example, a tube of metal, PVC, or other suitable material, and connected to each other by a flexible nylon strap. The upper arm and forearm sections of the arm component are filled with foam having a density of approximately four pounds per cubic foot, while the integral hand portion of the arm component is filled with foam having a density of approximately eight pounds per cubic foot. The higher density foam makes the hand stiffer and better suited to hold objects such as a weapon or a mobile phone that can serve to enhance the training scenario.

In a preferred embodiment of the invention, a shoulder mechanism with three mechanical joints serves to connect the upper arm to the torso, to enable full rotation of the arm in three dimensions, to lock the upper arm into one of a plurality of fixed positions, and to return the upper arm to its fixed position after an external disturbance. The first two joints allow 360 degree rotation of the arm about the shoulder pitch and roll axes and incorporate a locking mechanism that maintains the arm in a desired position (with the mannequin standing upright and arms fully extended forward and parallel to the ground, rotation about the pitch axis results in arm movement up or down, and rotation about the roll axis results in the arm spinning about its longitudinal center line while continuing to be extended forward). Each pitch and roll axis joint is formed by two adjacent flat plates made of metal, plastic or other hardened polymer material having aligned central apertures and a common axle, wherein one adjacent surface is stationary and the other may rotate freely about their common axle. Each flat plate is further arrayed with a plurality of additional apertures such that different apertures in adjacent surfaces may come into alignment with each other as the arm is rotated. A spring-loaded indexing pin is mounted on one of the two plates such that it may penetrate the aligned apertures of both plates, locking them together and preventing further rotation with respect to each other. The stationary plate is clamped to a fixed bulkhead by high friction load. The plate will slip on its axle relative to the bulkhead when sufficient torque is applied, acting to limit the load applied to the indexing pin and ensuring that it cannot be broken in use.

The pitch and roll joints in the shoulder mechanism are used to position the arm in a desired pose as described above. A third mechanical joint in the shoulder mechanism incorporates a resilient element that allows arm movement in three dimensions while the other joints remain locked in position; the resilient element also acts to restore the arm to its original posed position after the disturbing force is removed. In a preferred embodiment of the invention, the third joint is formed using a mechanical link of two nominally U-shaped fasteners linked through each other then passed through a section of a highly resilient elastomer spring. The linked U-shaped fasteners fit through an orthogonal cross-shaped opening in the elastomer spring, constraining them in all three axes. The open ends of each U-shaped fastener exit the elastomer spring and immediately pass through circular flat plates on both sides of the elastomer spring. After exiting these plates one U-shaped fastener is attached to the shoulder and the other U-shaped fastener is attached to the humerus segment. Threading the two U-bolts into place establishes a mechanical pre-load on the elastomer spring, providing the initial load necessary to support the joint against the weight of gravity and setting an initial stiffness to the joint. Any load applied to the arm in either the pitch or yaw axis tends to rotate the U-shaped fasteners relative to each other bringing one edge of the attached flat plates closer together and further compressing the elastomer spring. This increase in load on the elastomer spring increases the restorative force on the arm and will act to return the arm to its initial position once the disturbance is removed. Loads applied in the arms' rotational axis twist the two U-shaped fasteners together, pressing them against the walls of the cross-shaped cavity in the elastomer spring, and causing a distortion of the elastomer spring that results in an increasing restorative rotational force.

In another embodiment of the invention, the third resilient joint in the shoulder mechanism is formed using a compression spring housed within the humerus segment having one end restrained by the shoulder frame and the other end free to travel within the humerus segment. A flexible tensile member of fixed length grips rigidly onto the shoulder frame, passes through the center of the spring and attaches to another clamp on the free end of the spring to maintain the spring under tension. Any force applied to the arm tending to move it out of position creates tension in the cord and coils the compression spring; as the spring uncoils back to its resting position, it acts to return the arm to its original pose. Any motion of the arm in the pitch or yaw axes tends to rock the humerus up on its edges increasing the restorative force applied by the compression spring. The compression spring is installed under force providing a necessary pre-load that ensures the arm can support itself against gravity. The restorative force about the roll axis is achieved by the shape of the interface between the shoulder frame and the humerus member. The end of the humerus is shaped in the form of an obtuse isosceles triangle such that it mates with a similarly shaped socket on the shoulder frame. Any rotational force applied to the arm forces the humerus to ride up the walls of the triangular socket increasing the restorative force applied by the spring in the humerus.

In a preferred embodiment of the invention, the elbow joint in the arm component is realized with an elasticated rope with its ends tied together in a knot such that the rope fully encircles the elbow, running transversely through the upper forearm, across the topside of the arm's elbow area, transversely through the lower end of the upper arm (entering at the lower biceps and exiting at the lower triceps), and back across the bottom side of the elbow area to return to the upper forearm entry point. The upper forearm skeletal structure includes a tube mounted transversely to the radius segment that serves as a conduit for one side of the rope. A portion of the transverse forearm tube has a reduced interior diameter that is large enough to enable passage of the rope but too small to allow passage of the knot that ties the two ends of the rope together, such that the rope is rigidly gripped in place when the knot is drawn up against a restricted diameter section. The lower end of the upper arm skeletal structure includes a tube mounted transversely to the humerus segment that serves as a conduit for the other side of the rope. The upper arm transverse tube includes an interior constricting feature that grips the rope firmly in place under tension; the rope may be drawn through the constricting feature in the tube in only one direction, serving to increase the rope tension and reduce the angle between the forearm and upper arm. Pulling the rope at the triceps exit point upwards toward the upper arm temporarily releases the constricting feature, such that the rope can be drawn back in the other direction and its tension fully released. The rope tension adjustment feature allows the elbow to be set at any desired angle. Further, the resilient nature of the elasticated rope and the polyurethane foam material that forms the arm allow the elbow joint to be deflected from its preset position and to automatically return to that position. If an external force is applied to the arm that acts to increase the elbow angle from its preset position, the elasticated rope will stretch, thereby providing a counter restorative force; if an external force is applied to the arm reducing the elbow angle, the foam will compress, thereby providing a counter restorative force.

In a preferred embodiment of the invention, a hip mechanism with two mechanical joints serves to connect the upper leg to the hip, to enable 180 degrees of rotation about the pitch axis, to lock the upper leg into one of a plurality of fixed positions, and to return the upper leg to its fixed position after an external disturbance. The first joint allows 180 degree rotation of the leg about the hip pitch axis and incorporates a locking mechanism that maintains the leg in a desired position (with the mannequin standing upright and one leg fully extended forward and parallel to the ground, rotation about the pitch axis results in leg movement up or down, and rotation about the roll axis results in the leg spinning about its longitudinal center line while continuing to be extended forward). The pitch axis joint is formed by two adjacent flat plates made of metal, plastic, or other hardened material having aligned central apertures and a common axle, wherein one adjacent surface is stationary and the other may rotate freely about their common axle. Each flat plate is further arrayed with a plurality of additional apertures such that different apertures in adjacent surfaces may come into alignment with each other as the leg is rotated. A spring-loaded indexing pin is mounted on one of the two plates such that it may penetrate the aligned apertures of both plates, locking them together and preventing further rotation with respect to each other. The stationary plate is clamped to a fixed bulkhead by high friction load. The plate will slip on its axle relative to the bulkhead when sufficient torque is applied, acting to limit the load applied to the indexing pin and ensuring that it cannot be broken in use.

A preferred embodiment of the second resilient joint is formed using a mechanical link of two nominally U-shaped fasteners linked through each other then passed through a section of highly resilient elastomer spring. The linked U-shaped fasteners fit through an orthogonal cross-shaped opening in the elastomer spring, constraining them in all three axes. The open ends of each U-shaped fastener exit the elastomer spring and immediately pass through circular flat plates on both sides of the elastomer spring. After exiting these plates, one U-shaped fastener is attached to the positioning section of the hip and the other is attached to the femur segment. Threading the two U-shaped fasteners into place establishes a mechanical pre-load on the elastomer spring, providing the initial load necessary to support the joint against the weight of gravity and setting an initial stiffness to the joint. Any load applied to the leg in either the pitch or yaw axis tends to rotate the U-shaped fasteners relative to each other bringing one edge of the attached flat plates closer together and further compressing the elastomer spring. An increase in load on the elastomer spring increases the restorative force on the leg and acts to restore the leg to its original position once the disturbance is removed. Loads applied in the leg's rotational axis twist the two U-shaped fasteners together, pressing them against the walls of the cross-shaped cavity in the elastomer spring, and causing a distortion of the elastomer spring that results in an increasing restorative rotational force.

In a preferred embodiment of the invention, a knee mechanism with two mechanical joints serves to connect the upper leg to the lower leg, to enable approximately 160 degrees of rotation in the pitch axis, to lock the upper leg into one of a plurality of fixed positions, and to return the lower leg to its fixed position after an external disturbance. The first joint allows approximately 160 degree rotation of the leg about the knee pitch axis and incorporates a locking mechanism that maintains the leg in a desired position (with the mannequin standing upright and having its legs straight down beneath it, rotation about the pitch axis results in lower leg movement up behind the upper leg, and rotation about the roll axis results in the leg spinning about its longitudinal center line while continuing to be extended down). The pitch axis joint is formed by two adjacent flat plates made of metal, plastic, or other hardened material having aligned central apertures and a common axle, wherein one adjacent surface is stationary and the other may rotate freely about their common axle. Each flat plate is further arrayed with a plurality of additional apertures such that different apertures in adjacent surfaces may come into alignment with each other as the leg is rotated. A spring-loaded indexing pin is mounted on one of the two plates such that it may penetrate the aligned apertures of both plates, locking them together and preventing further rotation with respect to each other. The stationary plate is clamped to a fixed bulkhead by high friction load. The plate will slip on its axle relative to the bulkhead when sufficient torque is applied, acting to limit the load applied to the indexing pin and ensuring that it cannot be broken in use.

In a preferred embodiment of the invention, each mannequin leg component is made from a resilient polyurethane elastomer skin shell filled with flexible polyurethane foam material formed into clam shell halves that enclose and are attached to the skeletal leg components using common threaded fasteners. The hip and the upper and lower leg components are filled with foam having a density of approximately four pounds per cubic foot.

According to another aspect of the invention, an innovative mounting system is disclosed that allows the mannequin to exhibit dynamic fighting responses. The mounting system is composed of inelastic flexible support members and elastic members forming a web that support the mannequin and allow it to swing back and forth in space in reaction to user strikes. The system is arranged in a manner that always returns the mannequin to its original opponent-facing position.

Other features and advantages of the present invention are described in the following detailed description of the invention, which refers to the accompanying drawings.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a sectional front view of a preferred embodiment of the inventive training mannequin apparatus;

FIG. 2 is a sectional side view of a preferred embodiment of an arm component assembly of the inventive training mannequin apparatus;

FIG. 3 is an exploded isometric view of a preferred embodiment of the internal skeletal elements of the arm component assembly of FIG. 2;

FIG. 4 is an sectional side view of a preferred embodiment of the elbow joint of the arm component assembly of FIG. 2;

FIG. 5 is a sectional side view of an embodiment of a leg component assembly of the inventive training mannequin apparatus;

FIG. 6 is an exploded isometric view of a preferred embodiment of the internal skeletal elements of the leg component assembly of FIG. 5;

FIG. 7 is a sectional side view of an alternate embodiment of an arm component assembly of the inventive training mannequin apparatus;

FIG. 8 is an exploded isometric view of a preferred embodiment of the internal skeletal elements of the alternate arm component assembly of FIG. 7;

FIG. 9 is an isometric view of an alternate embodiment of a leg component assembly of the inventive training mannequin apparatus;

FIG. 10 is a front view of a training mannequin mounting apparatus; and

FIG. 11 is a front view of an alternate embodiment of a training mannequin mounting apparatus.

### DETAILED DESCRIPTION

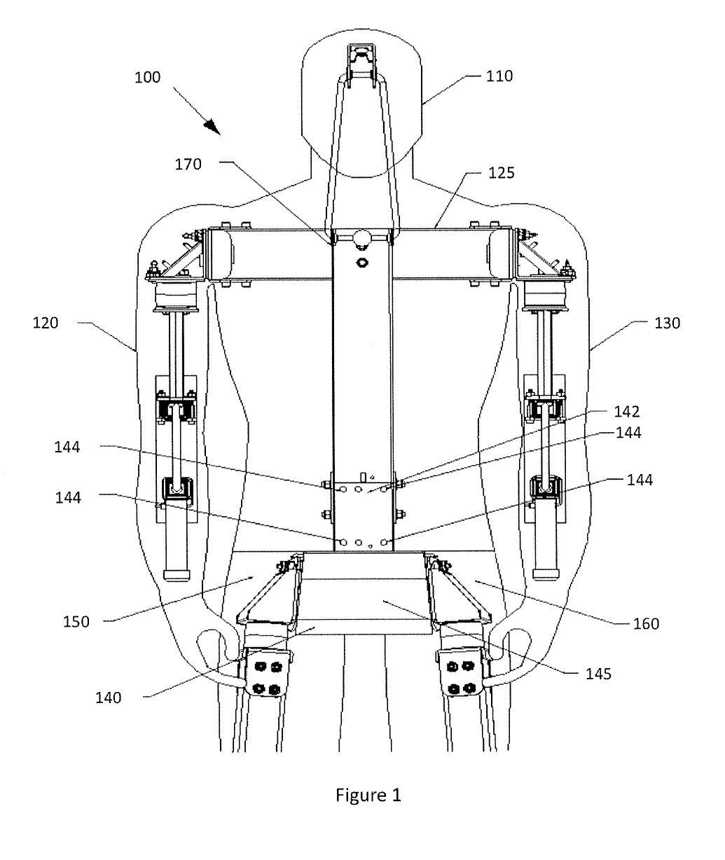

Referring now to the drawing, in which like reference numbers refer to like elements throughout the various figures that comprise the drawing, FIG. 1 illustrates a preferred embodiment of the training mannequin 100 including a torso component 110, and a plurality of limb assemblies, including a left arm component 120, a right arm component 130, and an optional leg pair including a hip component 140, a left leg component 150, and a right leg component 160. Torso component 110 may be sculpted to substantially resemble, in shape and size, a life-size human person, possibly in the form of a muscular male human combatant. Torso component 110 may include an integral trunk section, a neck section, and a head section. Each of the plurality of limb assemblies is attached to the torso component at a limb attachment point. For example, the left arm component 120 and right arm component 130 are mounted to torso component 110 by a shoulder plate 125 that extends between left arm component 120 and right arm component 130 at or near the shoulder area of torso component 110. Hip component 140 is mounted to torso component 110 by a hip connector plate 142 through hip connector plate apertures 144. Hip connector plate 142 is connected to a torso spine plate 170 which is in turn connected to a shoulder plate 125. Left leg component 150 and right leg component 160 are mounted to hip connector plate 142 by a hip plate 145 that extends between left leg component 150 and right leg component 160. Each of the limb assemblies is attached to the torso component in such a manner that it is adjustable in one or more axes of rotation, and each of the limb assemblies has a pre-loaded spring element capable of supporting the weight of the limb and returning the limb to its initial position if the limb is disturbed from the initial position by an external force. The manner in which the spring element operates and is incorporated into the various limb assemblies is described in more detail below. Section 1 describes a mannequin arm assembly where the pre-loaded spring element is an elastomer spring. Section 2 describes a mannequin arm assembly where the pre-loaded spring element is a compression spring. Section 3 describes a mannequin leg assembly where the pre-loaded spring element is an elastomer spring. Section 4 describes a mannequin leg assembly without a the pre-loaded spring element. Section 5 describes a mounting apparatus for a mannequin including inelastic flexible support members and elastic members.

### 1. Mannequin Arm Assembly

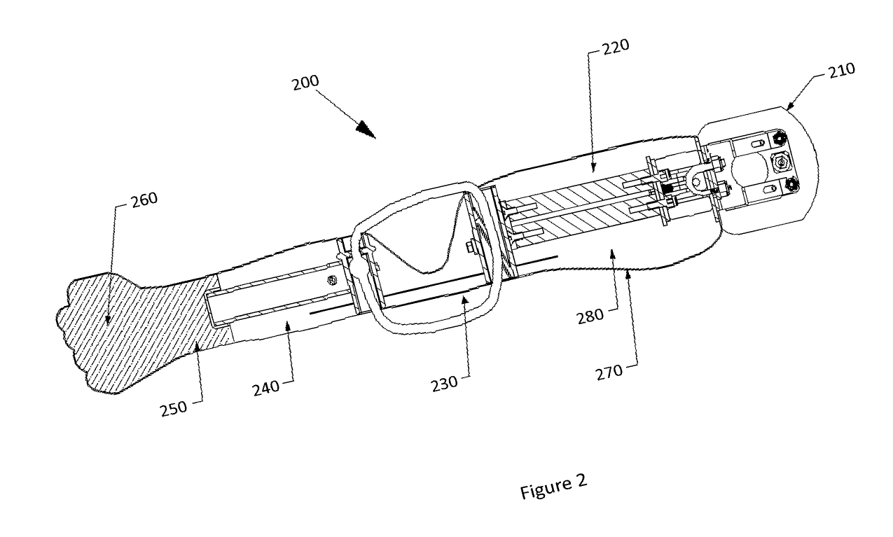

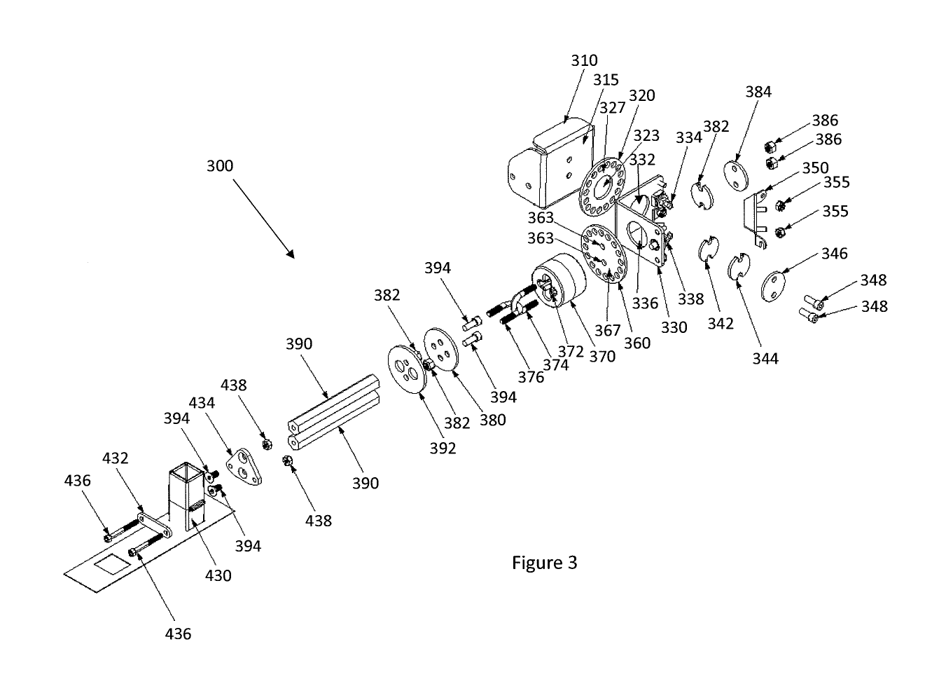

Referring to FIG. 2, a preferred embodiment of a mannequin arm assembly 200 is shown in sectional side view. Either or both of left arm component 120 and right arm component 130 may include mannequin arm assembly 200. The external shape of mannequin arm assembly 200 is designed to be anatomically similar to a human arm, having a shoulder section 210, an upper arm section 220, an elbow joint 230, a forearm section 240, a wrist section 250, and a hand component 260. Mannequin arm assembly 200 is constructed primarily from a covering skin 270, supporting foam 280, and various internal arm skeletal elements 300 (FIG. 3) as further described below. Hand component 260 of mannequin arm assembly 200 is filled with increased density flexible foam (i.e., greater than the density of supporting foam 280) to provide additional strength to both wrist section 250 and hand component 260.

In a preferred embodiment of the invention, and in further detail, mannequin arm assembly 200 includes a mechanism having four joints, each performing a distinct function within mannequin arm assembly 200. The first three joints are part of shoulder section 210 and the fourth joint is part of elbow joint 230. The first joint controls the positioning of mannequin arm assembly 200 along the shoulder pitch axis (e.g., assuming an upright mannequin with outstretched arms, rotation about the pitch axis allows arm movement up or down). The second joint of mannequin arm assembly 200 controls the arm positioning about the shoulder rotation axis (e.g., rotating the straightened arm about its longitudinal axis). The third joint of mannequin arm assembly 200 provides the spring-assist recovery function of the shoulder mechanism. The fourth joint of mannequin arm assembly 200 controls the positioning and resilient recovery of elbow joint 230.

The first joint (i.e., the arm pitch axis joint) controls the positioning of mannequin arm assembly 200 (FIG. 2) about the shoulder pitch axis (e.g., assuming an upright mannequin with outstretched arms, rotation about the pitch axis allows arm movement up or down). Referring to FIG. 3 showing an exploded view of internal arm skeletal elements 300 contained within shoulder section 210 (FIG. 2) and upper arm section 220 (FIG. 2), the pitch axis joint includes an inboard plate 310 which is stationary relative to torso component 110 (FIG. 1) of mannequin 100 (FIG. 1), a first indexing plate 320 including a central aperture 323, an outboard plate 330 including a first central aperture 332, and a central axle including a first axle plate 342, a second axle plate 344, and a first end plate 346. The first axle plate 342 has a diameter less than the diameter of the central aperture 323 of the first indexing plate 320 and fits in the central aperture 323. The second axle plate 344 has a diameter less than the diameter of the central aperture 332 of the outboard plate 330 and fits in the central aperture 332. Inboard plate 310 has two apertures in its face 315 which are threaded receptacles to receive fasteners 348 after they pass through apertures in first indexing plate 320, outboard plate 330, first axle plate 342, second axle plate 344, and first end plate 346. The diameter of the central aperture 323 of the indexing plate 320 is less than the diameter of the central aperture 332 of the outboard plate 330, so that the second axle plate 344 is too large to fit in the central aperture 323 of the indexing plate 320. First axle plate 342 is made of a nominally thinner material than first indexing plate 320 so that a compressive force applied by fasteners 348 presses inboard plate 310, second axle plate 344, and first indexing plate 320 together. This compressive force acts as a friction clutch to protect a first spring-loaded indexing pin 334 by allowing first indexing plate 320 to slip relative to inboard plate 310 when high torques are applied.

First indexing plate 320 has a plurality of indexing apertures 327 arrayed upon its face, including the central aperture 323. The remaining indexing apertures 327 of first indexing plate 320 are arrayed radially about the central aperture 323. These indexing apertures 327 are female sockets that receive first spring-loaded indexing pin 334 that is mounted on outboard plate 330.

When tension is applied to first spring-loaded indexing pin 334, it is drawn clear of indexing apertures 327 of first indexing plate 320, allowing outboard plate 330 and the attached apparatus to rotate freely about its central axle consisting of first axle plate 342, second axle plate 344, first end plate 346, and fasteners 348. Releasing the tension on first spring-loaded indexing pin 334 allows it to drop into the next available indexing aperture 327 on indexing plate 320, thereby locking outboard plate 330 in place and preventing rotation of outboard plate 330 with respect to first indexing plate 320. Outboard plate 330 is concentrically located along the same axis as indexing plate 320 through second axle plate 344. End plate 346 acts as a cap to keep outboard plate 330, first axle plate 342, first indexing plate 320, and second axle plate 344 from moving axially. Outboard plate 330 is reinforced by attaching a gusset 350 using threaded fasteners 355.

The second joint (i.e., the arm rotation axis joint) of mannequin arm assembly 100 (FIG. 2) controls the positioning of the mannequin arm assembly 100 about the shoulder rotation axis (e.g., rotating the straightened arm about its longitudinal axis). Referring to FIG. 3 showing an exploded view of internal arm skeletal elements 300 contained within shoulder section 210 (FIG. 2) and the upper arm section 220 (FIG. 2), the arm rotation axis joint consists of outboard plate 330, which is fixed about the rotation axis relative to torso component 110 (FIG. 2.) through the action of the pitch axis joint, a second indexing plate 360, an elastomer spring 370, and a central axle consisting of a first U-shaped fastener 374, a third axle plate 382, a second end plate 384, and fasteners 386. Third axle plate 382 acts as the axle for the arm rotation axis joint resting in a central aperture 336 of outboard plate 330. Second end plate 384 and second indexing plate 360 are positioned on either side of third axle plate 382 in outboard plate 330 to restrain the assembly from moving axially.

First U-shaped fastener 374 passes through a cross-shaped aperture 372 in elastomer spring 370, a pair of central apertures 363 in second indexing plate 360, third axle plate 382, and second end plate 384 and then is secured using fasteners 386. Fasteners 386 may be threaded nuts. The remaining indexing apertures 367 on the face of second indexing plate 360 are arrayed radially about the central apertures 363. These indexing apertures 367 of second indexing plate 360 are female sockets that receive a second spring-loaded indexing pin 338 that is mounted on outboard plate 330. When tension is applied to spring-loaded indexing pin 338 it is drawn clear of the indexing apertures 367 of the second indexing plate 360, allowing second indexing plate 360 and the attached apparatus to rotate freely about its central axle consisting of first U-shaped fastener 374, third axle plate 382, second end plate 384, and fasteners 386. Releasing the tension on second spring-loaded indexing pin 338 allows it to drop into the next available indexing aperture 367 on second indexing plate 360, thereby locking second indexing plate 360 in place and preventing rotation of second indexing plate 360 with respect to outboard plate 330.

The third joint (i.e., the arm recovery joint) of mannequin arm assembly 200 (FIG. 2) provides the spring assist recovery function of the shoulder mechanism. When mannequin arm assembly 200 is displaced by an external force from the preset position established by the pitch axis joint and rotation axis joint, the recovery joint acts to recover that preset position. Referring to FIG. 3 showing an exploded view of internal arm skeletal elements 300 contained within shoulder section 210 (FIG. 2) and upper arm section 220, the arm recovery joint includes elastomer spring 370, first U-shaped fastener 374, a second U-shaped fastener 376, a third end plate 380, humerus segments 390, and a humerus plate 392.

First U-shaped fastener 374 and second U-shaped fastener 376 pass through orthogonal cross-shaped aperture 372 in elastomer spring 370. Then first U-shaped fastener 374 passes through second indexing plate 360, third axle plate 382 and second end plate 384 where it is secured by fasteners 386. Second U-shaped fastener 376 exits elastomer spring 370 then passes through third end plate 380 where it is secured by fasteners 386. Fasteners 386 may be threaded nuts. Third end plate 380 is fastened to humerus segments 390 and humerus plate 392 using fasteners 394. Tightening fasteners 386 allows adjustment of the pre-load on elastomer spring 370.

Any load tending to deflect mannequin arm assembly 200 about the pitch or yaw axis pivots third end plate 380 relative to second indexing plate 360 around the link of first U-shaped fastener 374 and second U-shaped fastener 376. This deflection tends to compress elastomer spring 370. That compression increases the restoring force that acts to bring mannequin arm assembly 200 back to its preset position. When mannequin arm assembly 200 is disturbed about the rotation axis, first U-shaped fastener 374 and second U-shaped fastener 376 rotate relative to each other and distort orthogonal cross-shaped aperture 372 in elastomer spring 370, thereby increasing the restoring force that tends to bring mannequin arm assembly 200 back to its initial position.

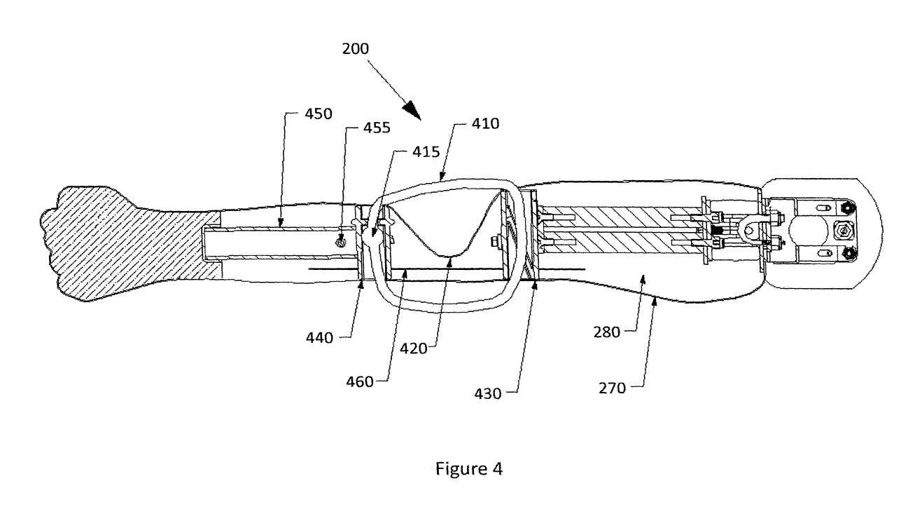

The fourth joint (i.e., the elbow positioning joint) of mannequin arm assembly 200 controls the positioning and resilient recovery of elbow joint 230. Referring to FIG. 4, the position of the fourth joint is controlled in concert by the tension in an elasticated rope 410 and the compression of a flexible hinge 420. The tension in elasticated rope 410 is controlled by a transverse humerus elbow tube 430 and a transverse radius elbow tube 440. Transverse humerus elbow tube 430 is secured between a pair of humerus elbow plates 432 and 434 by threaded fasteners 436, and threaded nuts 438, as shown in FIG. 3. Humerus elbow plate 434 is secured to humerus bone segments 390 by fasteners 394.

The upper arm skeletal assembly is secured to supporting foam 280 and covering skin 270 by co-molding and adhesion created during the mannequin molding process. Transverse radius elbow tube 440 is secured to a radius segment 450 by a strap 455 and is secured to supporting foam 280 and covering skin 270 by co-molding and adhesion created during the mannequin molding process. Elasticated rope 410 is looped through transverse humerus elbow tube 430 and radius elbow tube 440, and its ends are tied together in a knot 415 such that it entirely encircles the elbow. Knot 415 is captured within radius elbow tube 440 having an aperture that is too small to allow the knot 415 to pass through. In preferred embodiments, humerus elbow tube 430 may have internal features designed to grip and release elasticated rope 410 to adjust the preset elbow angle desired by a user. As elasticated rope 410 is drawn through the upper side of transverse humerus elbow segment 430, the tension in elasticated rope 410 increases, acting to reduce the angle of the elbow. Friction forces between the elasticated rope 410 and the transverse radius elbow tube 440 acts to maintain the angle of the elbow in the new resting position. Any external force that thereafter changes the angle of the elbow from the resting position increases the compression of the foam in flexible hinge 420 and increases the bend in the reinforcing fabric 460. The combined compressive and tensile forces accordingly act to restore the elbow to its resting position.

### 2. Mannequin Leg Assembly

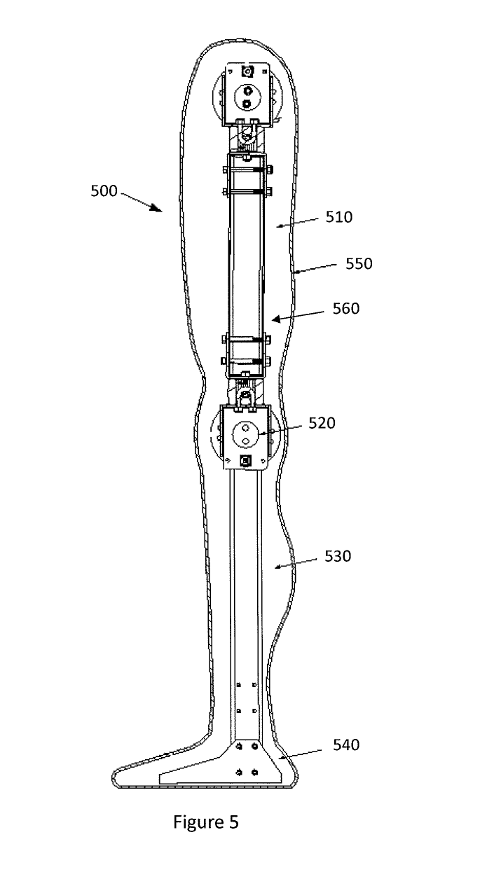

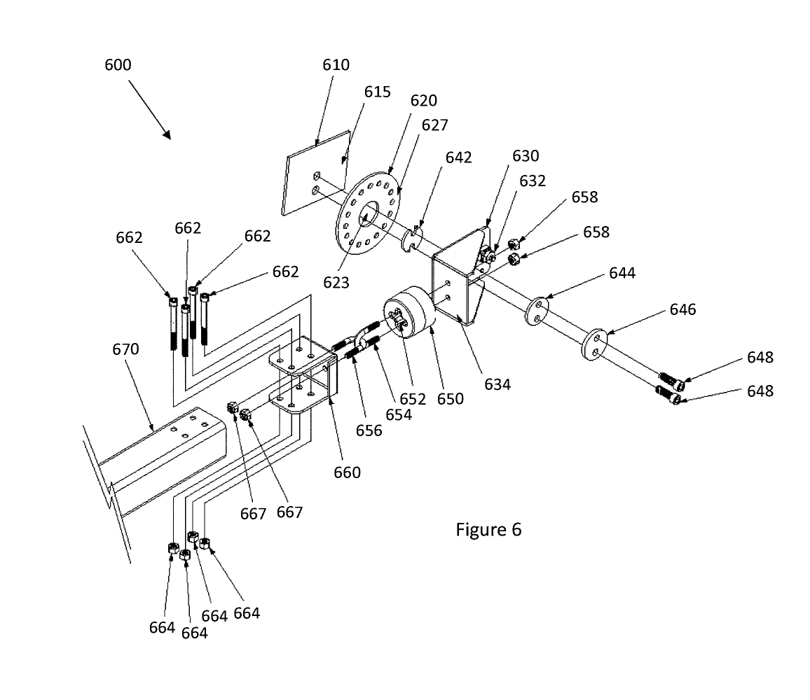

Referring to FIG. 5, in a preferred embodiment of the invention, and in further detail, a mannequin leg assembly 500 is comprised of a hip mechanism having two joints, each performing a distinct function within mannequin leg assembly 500. Either or both of left leg component 150 (FIG. 1) and right leg component 160 (FIG. 1) may include mannequin leg assembly 500 (FIG. 5). The first joint (i.e., the leg pitch axis joint) controls the positioning of mannequin leg assembly 500 in the hip pitch axis (e.g., assuming a mannequin standing straight up on a flat surface, rotation about the pitch axis allows leg movement forward or backward). The second joint of mannequin leg assembly 500 provides the spring assist recovery function of the hip mechanism. The external shape of mannequin leg assembly 500 is designed to be anatomically similar to a human leg, having a thigh section 510, a knee joint 520, a calf section 530, and a foot section 540. Mannequin leg assembly 500 is constructed primarily from a covering skin 550, a supporting foam 560, and various internal leg skeletal elements 600 (FIG. 6) as further described below.

Referring to FIG. 6 showing an exploded view of internal leg skeletal elements 600 contained within the hip section, the leg pitch axis joint of leg assembly 500 includes an inboard plate 610 which is stationary relative to hip component 140 of mannequin 100, an indexing plate 620 including a central aperture 623, an outboard plate 630 including a central aperture (not visible), and a central axle including a first axle plate 642, a second axle plate 644, and an end plate 646. The first axle plate 642 has a diameter less than the diameter of the central aperture 623 of the first indexing plate 620 and fits in the central aperture 623. The second axle plate 644 has a diameter less than the diameter of the central aperture of the outboard plate 630 and fits in the central aperture. Inboard plate 610 has two apertures in its face 615 which are threaded receptacles to receive fasteners 648 after they pass through apertures in indexing plate 620, first axle plate 642, outboard plate 630, second axle plate 644, and end plate 646. The diameter of the central aperture 623 of the indexing plate 620 is less than the diameter of the central aperture of the outboard plate 630, so that the second axle plate 644 is too large to fit in the central aperture 623 of the indexing plate 620. First axle plate 642 is of nominally thinner material than indexing plate 620 so that a compressive force applied by fasteners 648 presses inboard plate 610, indexing plate 620, and second axle plate 644 together. This compressive force acts as a friction clutch to protect a spring-loaded indexing pin 632 by allowing indexing plate 620 to slip relative to inboard plate 610 when high torques are applied.

Indexing plate 620 has a plurality of apertures arrayed upon its face, including the central aperture 623. The remaining indexing apertures 627 on the face of inboard plate 620 are arrayed radially about central aperture 623. These indexing apertures 627 are female sockets that may receive spring-loaded indexing pin 632 that is mounted on outboard plate 630.

When tension is applied to spring-loaded indexing pin 632, it is drawn clear of indexing apertures 627 of indexing plate 620, allowing outboard plate 630 and the attached apparatus to rotate freely about its central axle consisting of first axle plate 642, second axle plate 644, end plate 646, and fasteners 648. Releasing the tension on spring-loaded indexing pin 632 allows it to drop into the next available indexing aperture 627 on indexing plate 620, thereby locking outboard plate 630 in place and preventing rotation of outboard plate 630 with respect to indexing plate 620. Outboard plate 630 is concentrically located along the same axis as indexing plate 620 through second axle plate 644. End plate 646 acts as a cap to keep outboard plate 630, first axle plate 642, indexing plate 620, and second axle plate 644 from moving axially.

The second joint (the leg recovery joint) of mannequin leg assembly 500 provides the spring assist recovery function of the hip mechanism. When mannequin leg assembly 500 is displaced by an external force from the preset position established by the leg pitch axis joint, the leg recovery joint acts to recover that preset position. Referring to FIG. 6 showing an exploded view of internal leg skeletal elements 600 contained within the hip section, the leg recovery joint of leg assembly 500 includes an elastomer spring 650, a first U-shaped fastener 654, a second U-shaped fastener 656, a femur plate 660, and a femur segment 670. First U-shaped fastener 654 and second U-shaped fastener 656 pass through an orthogonal cross-shaped aperture 652 in elastomer spring 650. Then first U-shaped fastener 654 passes through apertures on a face 634 of outboard plate 630 where it is secured by threaded nuts 658.

Second U-shaped fastener 656 exits elastomer spring 650 then passes through femur plate 660 where it is secured by threaded nuts 667. Femur plate 660 is fastened to femur segment 670 using fasteners 662 and threaded nuts 664. By tightening threaded nuts 658 it is possible to adjust the pre-load on elastomer spring 650. Any load tending to deflect the leg about the pitch or yaw axis pivots femur plate 660 relative to outboard plate 630 around the link of first U-shaped fastener 654 and second U-shaped fastener 656. This deflection tends to compress sections of elastomer spring 650, and increase the restoring force that acts to bring the leg back to its preset position. When the leg is disturbed about the rotation axis, first U-shaped fastener 654 and second U-shaped fastener 656 rotate relative to each other and distort orthogonal cross-shaped aperture 652 in elastomer spring 650, thereby increasing the restoring force that acts to bring the leg back to its initial position.

### 3. Alternate Mannequin Arm Assembly

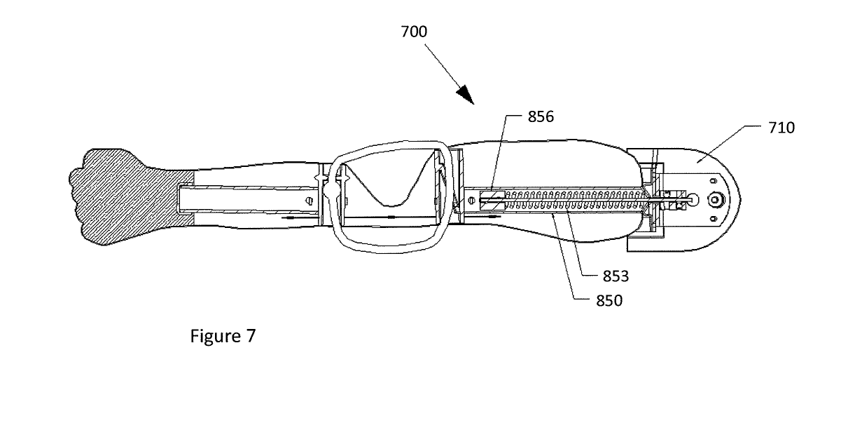

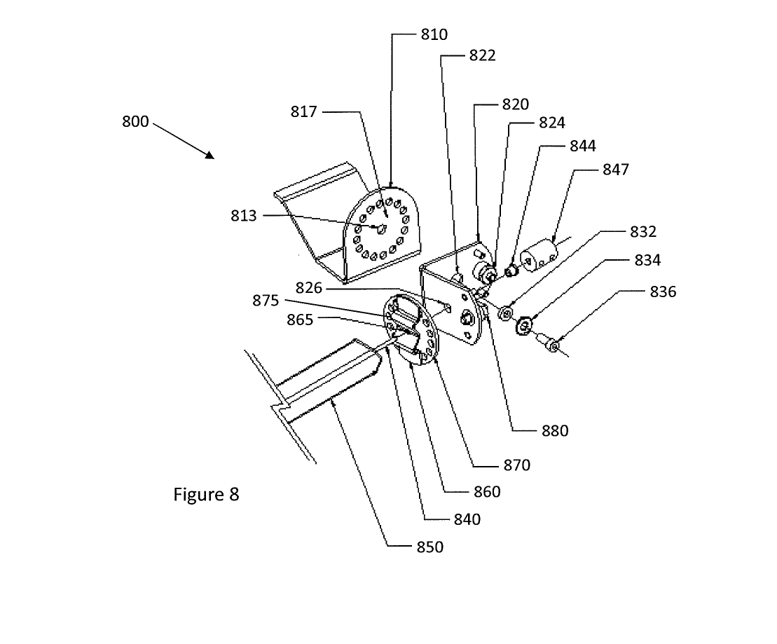

Referring to FIG. 7 and FIG. 8, an alternate embodiment to mannequin arm assembly 200 of FIG. 2, namely an alternate arm assembly 700, is shown. In particular, an alternate shoulder section 710 of alternate arm assembly 700 has three joints, each performing a distinct function within alternate arm assembly 700. Alternate arm assembly 700 is constructed in part by various internal shoulder skeletal elements 800 (FIG. 8) as further described below. The first joint controls the positioning of alternate arm assembly 700 about the shoulder pitch axis. The second joint of alternate arm assembly 700 controls the positioning of alternate arm assembly 700 about the shoulder roll axis. The third joint of alternate arm assembly 700 provides the spring assist recovery function of alternate shoulder section 710.

The first joint (i.e., the arm pitch axis joint) controls the positioning of the alternate arm assembly 700 about the shoulder pitch axis. Referring to FIG. 7 showing alternate arm assembly 700 in a sectional side view and FIG. 8 showing an exploded view of the various internal shoulder skeletal elements 800 of alternate shoulder section 710, the pitch axis joint includes an inboard plate 810 which is stationary relative to torso component 110 of mannequin 100, an outboard plate 820, and a central axle consisting of a radial bushing 832, a thrust washer 834, and a threaded fastener 836. Inboard plate 810 has a plurality of indexing apertures 817 arrayed upon its face surrounding a central aperture 813. Central aperture 813 within inboard plate 810 receives threaded fastener 836 which clamps radial bushing 832, thrust washer 834, and one flange of outboard plate 820 through first central aperture 822 located in outboard plate 820 to inboard plate 810. The remaining indexing apertures 817 on the face of inboard plate 820 are arrayed radially about central aperture 813. These indexing apertures 817 are female sockets that receive a first spring-loaded indexing pin 824 that is mounted on outboard plate 820. When tension is applied to first spring-loaded indexing pin 824 it is drawn clear of indexing apertures 817 of inboard plate 810, allowing outboard plate 820 and the attached apparatus to rotate freely about its central axle consisting of radial bushing 832, thrust washer 834, and threaded fastener 836. Releasing the tension on first spring-loaded indexing pin 824 allows it to drop into the next available indexing aperture 817 of inboard plate 810, thereby locking outboard plate 820 in place and preventing rotation of outboard plate 820 with respect to inboard plate 810.

The second joint (i.e., the arm roll axis joint) of alternate arm assembly 700 controls the positioning of alternate arm assembly 700 along the shoulder roll axis. Referring again to FIG. 7 showing alternate arm assembly 700 in a sectional side view and FIG. 8 showing an exploded view of the various internal shoulder skeletal elements 800 of alternate shoulder section 710, the roll axis joint is anchored to the flange on outboard plate 820 that is nominally perpendicular to the flange for the arm pitch axis joint described above. A flexible tensile member 840 extends from a humerus segment 850 through a central aperture 865 of a cam 860 and an indexing plate 870, as well as a second central aperture 826 located on outboard plate 820 and continuing through an alignment bushing 844 and finally secured within a clamp 847. Alignment bushing 844 ensures that apertures 865 and 826 cannot be misaligned while it is installed. Indexing plate 870 has a plurality of indexing apertures 875 radially arrayed about its central aperture 865, acting as sockets to receive a second spring-loaded indexing pin 880 mounted to the same flange of outboard plate 820 as aperture 826. When tension is applied to second spring-loaded indexing pin 880, it is drawn clear of the apertures or sockets on indexing plate 870, allowing indexing plate 870 and the attached apparatus to rotate freely about its central axle which is made of flexible tensile member 840, alignment bushing 844, and clamp 847. Releasing the tension on second spring-loaded indexing pin 880 allows the pin to drop into an indexing aperture 875 on indexing plate 870, thereby locking outboard plate 820 in place and preventing rotation of outboard plate 820 with respect to inboard plate 810. Tension is maintained in both the pitch axis and roll axis joints through the action of the third joint described below.

The third joint (i.e., the arm recovery joint) of alternate arm assembly 700 provides the spring assist recovery function of alternate arm assembly 700. When alternate arm assembly 700 is displaced by an external force from the preset position established by the arm pitch axis joint and the arm roll axis joint, the third joint acts to recover that preset position. Referring again to FIG. 7 showing alternate arm assembly 700 in a sectional side view and FIG. 8 showing an exploded view of the various internal shoulder skeletal elements 800 of alternate shoulder section 710, the arm recovery joint consists of humerus segment 850, a housing pre-loaded compression spring 853, and a clamp 856, along with flexible tensile member 840 attaching at one end to clamp 856, extending through compression spring 853, exiting humerus segment 850 through aperture 865 of cam 860 and indexing plate 870, continuing through second central aperture 826 of outboard plate 820, through alignment bushing 844 and finally terminating in clamp 847. In operation, when alternate arm assembly 700 is disturbed from its resting position by an external force tending to rotate the lower arm about either or both of the roll or yaw axes (where the yaw axis is a rotation of arm alternate arm assembly 700 that would tend to spread the straightened arm out perpendicularly to the side of the torso), humerus segment 850 rocks in cam 860 such that their mating faces move apart, increasing the tension in flexible tensile member 840. The increased tension in flexible tensile member 840 acts to increase the force exerted by compression spring 853 thereby increasing the force acting to bring the mating faces of inboard plate 810 and the corresponding flange of outboard plate 820, along with indexing plate 870 and the corresponding flange of outboard plate 820, back together.

The third joint also provides the mechanism and forces to recover from forces that disturb alternate arm assembly 700 along the roll axis. When a force is applied to alternate arm assembly 700 that tends to rotate alternate arm assembly 700 about its longitudinal axis, the triangular faces of humerus segment 850 and cam 860 push each other apart. This action tends to increase the tension in flexible tensile member 840 and the restorative force applied by compression spring 853, acting to bring the mating triangular faces of humerus segment 850 and cam 860 back together.

### 4. Alternate Mannequin Leg Assembly

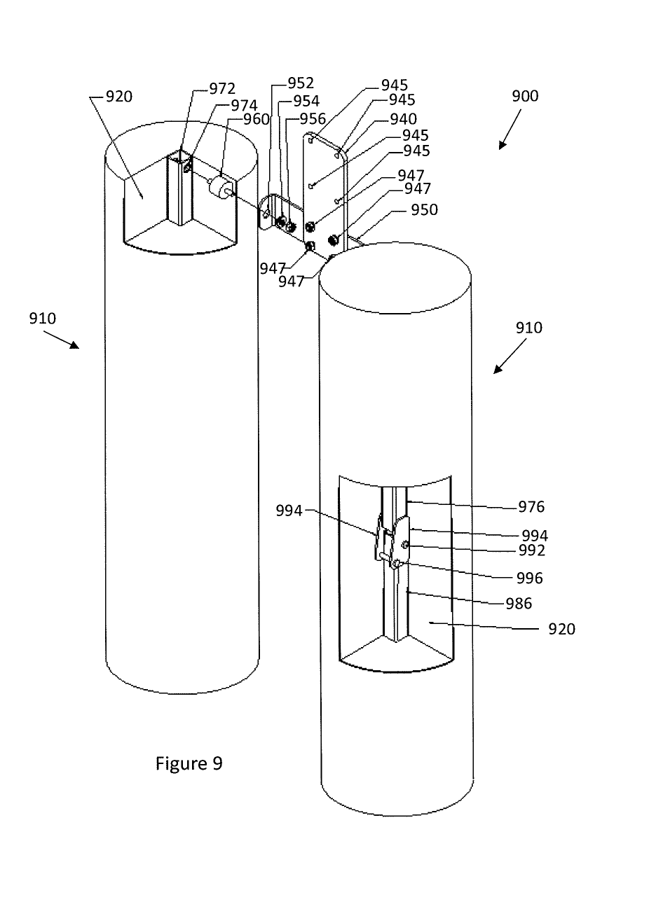

Referring to FIG. 9, an alternate embodiment to mannequin leg assembly 500 of FIG. 5, namely an alternate leg assembly 900, is shown. Alternate leg assembly 900 is shown in isometric view, with bilaterally symmetrical leg elements 910, each containing a hip joint and a knee joint. Alternate leg assembly 900 is covered with a pair of canvas pants (not shown) to secure the supporting foam pads 920 to an internal skeleton structure. Alternate leg assembly 900 is mounted to a torso spine plate (not shown) by a hip connector plate 940 via fasteners installed though a plurality of apertures 945. Hip connector plate 940 attaches to a hip plate 950 via a plurality of fasteners 947.

The left hip joint is attached to hip plate 950 through an aperture 952 and consists primarily of a flexible threaded elastomeric element 960 which is capable of flexing along three essentially orthogonal axes. Elastomeric element 960 is secured to hip plate 950 by a shoulder washer 954 and a nut 956. Shoulder washer 954 rotates freely in aperture 952 to ensure that no torque can be applied to unscrew nut 956 as a result of movement of the leg. The distal end of elastomeric element 960 is secured to the right femur segment 972 by a captive fastener 974. The right hip joint is similarly constructed.

Referring again to FIG. 9, an additional aspect of a preferred embodiment of the mannequin knee joint is shown in the partial sectional view of the left leg. The left leg consists of a left femur segment 976 and a right tibia segment 986 welded to a pair of knee fulcrum plates 994. A first pin 992 is mounted through aligned apertures of fulcrum plates 994, and right tibia element 986, such that it acts as the fulcrum point for the knee. A second pin 996 is also mounted through aligned apertures of fulcrum plates 994 to act as a forward travel stop for the knee joint to ensure that the joint cannot be hyper extended.

### 5. Mannequin Mounting Apparatus

Additional embodiments of the present invention may include an apparatus for mounting a training mannequin, for example the training mannequin 100 (FIG. 1) as described above. The mannequin may be mounted between an overhead support and a base support. One or more flexible members extend between one or more attachment points on an upper end of the training mannequin and the overhead support. One or more elasticated members extend between one or more attachment points on a lower end of the training mannequin and the base support. In various embodiments, the attachment points on the training mannequin may be on the outer surface of the training mannequin, or contained within the training mannequin, so that the flexible members and the elasticated members may extend partially into the training mannequin.

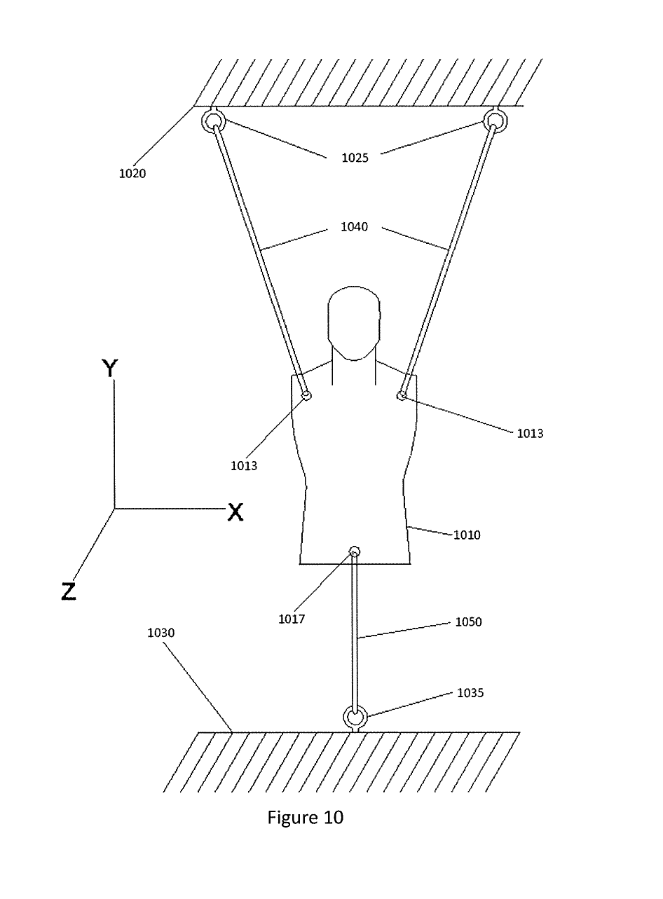

Referring to FIG. 10, in an exemplary embodiment, a pair of flexible members extend between the overhead support and a pair of attachment points on the upper end of the training mannequin, and a single elasticated member extends between the lower end of the mannequin and the base support. For example, a mannequin 1010, may be suspended between an overhead support 1020 and a base support 1030. The mannequin 1010, may include a pair of upper torso attachment points 1013 and a lower torso attachment point 1017. The mannequin 1010 may further include a pair of arms (not shown). The mannequin 1010 may further include a pair of legs (not shown).

Flexible supporting members 1040 extend down from overhead support attachment points 1025 of the overhead support 1020 and attach to the mannequin 1010 at the upper torso attachment points 1013. Lower elasticated member 1050 extends down from the lower torso attachment point 1017 of the mannequin 1010 and attaches to the base support attachment point 1035 of the base support 1030.

An axis system of the mannequin 1010 may be defined as having a X, Y, and Z axis as depicted in FIG. 10. When the mannequin is disturbed such that it translates along the X, Y or Z axes, or rotates about the Z or X axes, the elasticated member 1050 are stretched and act to spring the mannequin back to its original position in an underdamped manner. This underdamped response makes the user have to dodge and react to the moving target presented by the mannequin 1010. When the mannequin is rotated about the Y axis, the upper torso attachment points 1013 rotate with the mannequin 1010 and try to twist the flexible supporting members 1040 together. This tends to increase tension in flexible supporting members 1040 and lift the mannequin 1005 up in the Y axis which increases the tension in elasticated member 1050. The increased tension tends to return the mannequin 1010 to its original orientation in the Y axis in an underdamped motion. This underdamped response makes the user have to dodge and react to the moving target presented by the mannequin 1010.

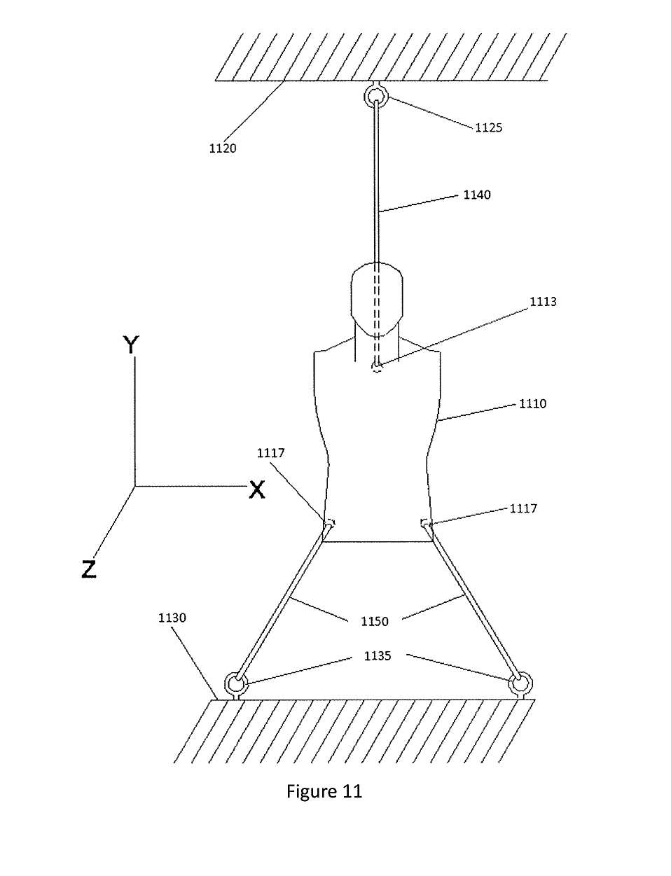

Referring to FIG. 11, a single flexible member extends between the overhead support and an attachment point on the upper end of the training mannequin, and a pair of elasticated members extend between the lower end of the mannequin and the base support. For example, a mannequin 1110 may be suspended between an overhead support 1120 and a base support 1130. The mannequin 1110, may include a pair of lower torso attachment points 1117 on a lower portion of the mannequin 1110 and an upper torso attachment point 1113 on an upper portion of the mannequin 1110. The mannequin 1110 may further include a pair of arms (not shown). The mannequin 1110 may further include a pair of legs (not shown).

A single flexible supporting member 1140 extends down from the overhead support attachment point 1125 of the overhead support 1120 and attaches to the mannequin 1110 at the upper torso attachment point 1113. A pair of lower elasticated members 1150 extends down from the lower torso attachment points 1117 of the mannequin 1110 and attach to the base support attachment points 1135 of the base support 1130.

An axis system of the mannequin 1110 may be defined as having a X, Y, and Z axis as depicted in FIG. 11. When the mannequin is disturbed such that it translates along the X, Y or Z axes, or rotates about the X, Y, or Z, the lower elasticated members 1150 are stretched and act to spring the mannequin back to its original position in an underdamped manner. This underdamped response makes the user have to dodge and react to the moving target presented by the mannequin 1110.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

What we claim is:

1. A mannequin for sparring, self-defense, law enforcement, and combat sports training, the mannequin comprising:
a torso component substantially resembling the torso of a human person and having a limb attachment point; and
a limb assembly connected to the limb attachment point of the torso component, the limb assembly having an initial position that is adjustable in one or more axes of rotation and having a pre-loaded spring element capable of supporting the limb in the initial position and returning the limb to the initial position after the limb is disturbed from the initial position by an external force.

2. The training mannequin of claim 1, wherein the limb assembly is an arm assembly comprising a shoulder section attached to the limb attachment point and a restoring joint including the pre-loaded spring element.

3. The training mannequin of claim 2, wherein the restoring joint comprises:
the pre-loaded spring element, wherein the pre-loaded spring element comprises an elastomer spring having an orthogonal cross-shaped aperture;
first and second linked U-shaped fasteners located within the orthogonal cross-shaped aperture of the elastomer spring, the first U-shaped fastener attached to an indexing plate adjacent to a first end of the elastomer spring, the second U-shaped fastener attached to an end plate adjacent to a second end of the elastomer spring opposite the first end of the elastomer spring; and
a humerus segment attached to the endplate adjacent to the second end of the elastomer spring,
wherein when the humerus segment is disturbed from a resting position about a yaw or a pitch axis of the shoulder section, the elastomer spring compresses, and the compression of the elastomer spring applies a restoring force to the humerus segment to return the humerus segment to the resting position,
wherein when the humerus segment is disturbed from the resting position about a rotation axis of the shoulder section, the first and second U-shaped fasteners distort the orthogonal cross-shaped aperture of the elastomer spring, thereby increasing a restoring force within the elastomer spring to return the humerus segment to the resting position.

4. The training mannequin of claim 2, wherein the restoring joint comprises:
a humerus segment having a hollow interior;
a cam adjacent to a first end of the humerus segment;
the pre-loaded spring element, wherein the pre-loaded spring element comprises a compression spring in the hollow interior of the humerus segment and a flexible tensile member extending through the compression spring and fastened to a first end of the humerus segment by a first clamp, further extending through the cam and fastened on a side of the cam opposite the humerus segment by a second clamp; and
wherein when the humerus segment is disturbed from a resting position by an external force, the humerus segment rocks in the cam such that their mating faces move apart increasing the tension in the flexible tensile member, the increase in tension in the flexible tensile member increases the force applied by the compression spring, and the force applied by the compression spring returns the humerus segment to the resting position.

5. The training mannequin of claim 2, wherein the arm assembly further comprises an adjustable joint to set the position of the arm assembly with respect to the pitch axis of the shoulder section, the adjustable joint comprising:
an inboard plate stationary relative to the torso component;
an indexing plate having a face including a first central aperture surrounded by a plurality of indexing apertures;
an outboard plate having a face including a second central aperture larger than the first central aperture of the indexing plate;
an axle attached to an inboard place having:
a first axle plate with a diameter less than the diameter of the first central aperture of the indexing plate, the axle plate located within the first central aperture of the indexing plate and fastened to the inboard plate, and
a second axle plate with a diameter less than the diameter of the second central aperture of the outboard plate yet larger than the diameter of the first central aperture of the indexing plate, the second axle plate located within the central aperture of the outboard plate and fastened to the inboard plate,
wherein the indexing plate is compressed between the inboard plate and the second axle plate, so that the indexing plate resists rotating with respect to the axle; and
an indexing pin attached to the outboard plate, the indexing pin sized to fit within any of the indexing apertures of the indexing plate and aligned to fit in any of the plurality of indexing apertures of the indexing plate,
wherein when the indexing pin is drawn clear of the indexing plate, the outboard plate may rotate relative to the axle.

6. The training mannequin of claim 2, wherein the arm assembly further comprises an adjustable joint to set the position of the arm assembly with respect to the pitch axis of the shoulder section, the adjustable joint comprising:
an inboard plate stationary relative to the torso component, the inboard plate including on its face a center aperture and a plurality of indexing apertures distributed radially around the center aperture;
an outboard plate including a face with a central aperture and an indexing pin attached to the face of the outboard plate, wherein when the central aperture of the outboard plate is aligned with the center aperture of the inboard plate, the indexing pin is aligned with any of the plurality of indexing apertures of the inboard plate; and
a central axle including a threaded fastener, a radial bushing, and a thrust washer, the central axle located within the center aperture of the inboard plate and the central aperture of the outboard plate,
wherein when the indexing pin is drawn clear of the plurality of indexing apertures of the inboard plate, the outboard plate may rotate relative to the inboard plate around the central axle.

7. The training mannequin of claim 2, wherein the arm assembly further comprises an adjustable joint to set the position of the arm assembly with respect to the roll axis of the shoulder section, the adjustable joint comprising:
an outboard plate having a central aperture on a face of the outboard plate;
an axle plate with a diameter less than the diameter of the central aperture of the outboard plate and located within the central aperture of the outboard plate;
an indexing plate fastened to the axle plate and having a plurality of indexing apertures arrayed radially on a face of the indexing plate; and
an indexing pin attached to the outboard plate and passing through one of the plurality of indexing apertures of the indexing plate,
wherein when the indexing pin is drawn clear of the plurality of indexing apertures, the indexing plate and axle plate may rotate relative to the outboard plate.

8. The training mannequin of claim 2, wherein the arm assembly further comprises an adjustable joint to set the position of the arm assembly with respect to the roll axis of the shoulder section, the adjustable joint comprising:
a humerus segment;
an indexing plate having a central aperture and a plurality of indexing apertures radially distributed around the central aperture on a face of the indexing plate;
an outboard plate having a central aperture on a face of the outboard plate and an indexing pin, wherein, when the central aperture of the outboard plate is aligned with the central aperture of the indexing plate, the indexing pin aligns with any of the plurality of indexing apertures; and
a flexible tensile member extending from the humerus segment through the central aperture of the indexing plate and the central aperture of the outboard plate, the flexible tensile member secured to the outboard plate with a clamp,
wherein, when the indexing pin is drawn clear of the plurality of indexing apertures, the indexing plate may rotate relative to the outboard plate around the flexible tensile member.

9. The training mannequin of claim 2, wherein the arm assembly further comprises an elbow joint, the elbow joint comprising:
a transverse humerus elbow tube having a first aperture and a second aperture;
a transverse radius elbow tube having a first aperture and a second aperture;
a flexible hinge connected to the transverse humerus elbow tube and the transverse radius elbow tube;
a reinforcing fabric connected to the transverse humerus elbow tube and the transverse radius elbow tube; and
an elasticated rope passing through the first aperture and the second aperture of the transverse humerus elbow tube and the first aperture and the second aperture of the transverse radius elbow tube, wherein a first end and a second end of the elasticated rope are tied in a knot within the transverse radius elbow tube and the knot is larger than the first aperture and the second aperture of the transverse radius elbow tube so that the knot cannot pass through the first aperture or the second aperture of the transverse radius elbow tube,
wherein drawing the elasticated rope through the transverse humerus elbow tube changes the angle of the elbow joint, and friction forces between the elasticated rope and the transverse elbow tubes act to thereafter maintain the angle of the elbow joint in a new resting position,
wherein when the elbow joint is disturbed from its resting position, compressive and tensile forces in the flexible hinge and the elasticated rope return the elbow joint to its resting position.

10. The training mannequin of claim 1, wherein the limb assembly comprises a hip component attached to the limb attachment point and a leg assembly attached to the hip component, the leg assembly having a restoring joint including the pre-loaded spring element.

11. The training mannequin of claim 10, wherein the restoring joint comprises:
the pre-loaded spring element, wherein the pre-loaded spring element comprises an elastomer spring having an orthogonal cross-shaped aperture;
first and second linked U-shaped fasteners within the orthogonal cross-shaped aperture of the elastomer spring, the first U-shaped fastener attached to an outboard plate adjacent to a first end of the elastomer spring, the second U-shaped fastener attached to a femur plate adjacent to a second end of the elastomer spring opposite the first end of the elastomer spring; and
a femur segment attached to the femur plate,
wherein when the femur segment is disturbed from a resting position about a yaw or pitch axis, the elastomer spring compresses, and the compression of the elastomer spring applies a restoring force to the femur segment to return the femur segment to the resting position, and
wherein when the femur segment is disturbed from the resting position about a rotation axis, the first and second U-shaped fasteners distort the orthogonal cross-shaped aperture of the elastomer spring, thereby increasing a restoring force within the elastomer spring to return the femur segment to the resting position.

12. The training mannequin of claim 10, wherein the leg assembly further comprises an adjustable joint to set the position of the leg assembly with respect to a pitch axis of the leg assembly, the adjustable joint comprising:
an inboard plate stationary relative to the hip component;
an indexing plate having a face with a central aperture surrounded by a plurality of indexing apertures;
an axle attached to an inboard place comprising:
a first axle plate with a diameter less than the diameter of the first central aperture of the indexing plate, the axle plate located within the first central aperture of the indexing plate and fastened to the inboard plate, and
a second axle plate with a diameter less than the diameter of the second central aperture of the outboard plate yet larger than the diameter of the first central aperture of the indexing plate, the second axle plate located within the central aperture of the outboard plate and fastened to the inboard plate,
wherein the indexing plate is compressed between the inboard plate and the second axle plate, so that the indexing plate resists rotating with respect to the axle; and
an indexing pin attached to an outboard plate, the indexing pin sized to fit within any of the plurality of indexing apertures of the indexing plate and aligned to fit in any of the plurality of indexing apertures of the indexing plate,
wherein when the indexing pin is drawn clear of the indexing plate, the outboard plate may rotate relative to the axle plate and indexing plate.

13. A mounting apparatus for a training mannequin substantially resembling the torso of a human person comprising:
an upper support adjacent to an upper end of the training mannequin;
a base support adjacent to a lower end of the training mannequin;
one or more flexible supporting members extending from one or more attachment points on the upper support to one or more upper torso attachment points on the upper end of the training mannequin; and
one or more elasticated members extending from one or more lower torso attachment points on the lower end of the training mannequin to one or more attachment points on the second support,
wherein when the training mannequin is disturbed from an initial position such that it translates along an X, Y, or Z axis of the training mannequin or rotates about the X, Y, or Z axis, the one or more elasticated members stretch and act to spring the training mannequin back to its original position in an underdamped manner.

14. The mounting apparatus of claim 13, wherein the training mannequin further comprises a pair of arms.

15. The mounting apparatus of claim 13, wherein the training mannequin further comprises a pair of legs.

16. The mounting apparatus of claim 13, wherein the apparatus comprises a pair of flexible supporting members and a single elasticated member.

17. The mounting apparatus of claim 16, wherein when the training mannequin is disturbed from the initial position such that it rotates about the Y axis the pair of flexible supporting members twist together and raise the training mannequin in the Y axis, thereby increasing tension in the single elasticated member which acts to spring the training mannequin back to its original position in an underdamped manner.

18. The mounting apparatus of claim 13, wherein the apparatus comprises a single flexible supporting member and a pair of elasticated members.

19. A mannequin for sparring, self-defense, law enforcement, and combat sports training, the mannequin comprising:
a torso component substantially resembling a human person, the torso component having a shoulder plate perpendicular to the length of the torso component; and
an arm assembly connected to the shoulder plate, first arm assembly having:
a shoulder section,
a first joint controlling movement about a pitch axis of the shoulder section relative to the torso component,
a second joint controlling motion either about a rotation axis or a roll axis of the shoulder section relative to the torso component, and
a third joint providing the shoulder section with a recovery function, whereby the third joint applies a restoring force to the shoulder section when disturbed about the rotation axis to return the shoulder section to an initial position after the disturbance is removed.

20. The mannequin of claim 19, wherein the first joint comprises:
an inboard plate stationary relative to the torso component;
an indexing plate having a face including a first central aperture surrounded by a plurality of indexing apertures;
an outboard plate having a face including a second central aperture larger than the first central aperture of the indexing plate;
an axle attached to an inboard place having:
a first axle plate with a diameter less than the diameter of the first central aperture of the indexing plate, the axle plate located within the first central aperture of the indexing plate and fastened to the inboard plate, and
a second axle plate with a diameter less than the diameter of the second central aperture of the outboard plate yet larger than the diameter of the first central aperture of the indexing plate, the second axle plate located within the central aperture of the outboard plate and fastened to the inboard plate,
wherein the indexing plate is compressed between the inboard plate and the second axle plate, so that the indexing plate resists rotating with respect to the axle; and
an indexing pin attached to the outboard plate, the indexing pin sized to fit within any of the indexing apertures of the indexing plate and aligned to fit in any of the plurality of indexing apertures of the indexing plate,
wherein when the indexing pin is drawn clear of the indexing plate, the outboard plate may rotate relative to the axle.

21. The mannequin of claim 19, wherein the second joint comprises:
an outboard plate having a central aperture on a face of the outboard plate;
an axle plate with a diameter less than the diameter of the central aperture of the outboard plate and located within the central aperture of the outboard plate;
an indexing plate fastened to the axle plate and having a plurality of indexing apertures arrayed radially on a face of the indexing plate; and
an indexing pin attached to the outboard plate and passing through one of the plurality of indexing apertures of the indexing plate,
wherein when the indexing pin is drawn clear of the plurality of indexing apertures, the indexing plate and axle plate may rotate relative to the outboard plate.

22. The mannequin of claim 19, wherein the third joint comprises:
an elastomer spring having an orthogonal cross-shaped aperture;
first and second linked U-shaped fasteners located within the orthogonal cross-shaped aperture of the elastomer spring, the first U-shaped fastener attached to an indexing plate adjacent to a first end of the elastomer spring, the second U-shaped fastener attached to an end plate adjacent to a second end of the elastomer spring opposite the first end of the elastomer spring; and
a humerus segment attached to the endplate adjacent to the second end of the elastomer spring,
wherein when the humerus segment is disturbed from its resting position about a yaw or pitch axis of the shoulder section, the elastomer spring compresses, and the compression of the elastomer spring applies a restoring force to the humerus segment to return the humerus segment to its resting position,
wherein when the humerus segment is disturbed from its resting position about a rotation axis of the shoulder section, the first and second U-shaped fasteners distort the orthogonal cross-shaped aperture of the elastomer spring, thereby increasing a restoring force within the elastomer spring to return the humerus segment to its resting position.

23. The mannequin of claim 19, further comprising:
a torso spine plate connected to the shoulder plate;
a hip connector plate connected to the torso spine plate;
a hip component connected to the hip connector plate; and
a leg assembly connected to the hip component, the leg assembly having:
a first joint positioning the mannequin leg assembly about a pitch axis; and
a second joint providing the mannequin leg assembly with a recovery function, whereby the second joint applies a restoring force to the mannequin leg.

24. The mannequin of claim 23, wherein the first joint of the leg assembly comprises:
an inboard plate stationary relative to the hip component;
an indexing plate having a face with a central aperture surrounded by a plurality of indexing apertures;
an axle attached to an inboard place comprising:
a first axle plate with a diameter less than the diameter of the first central aperture of the indexing plate, the axle plate located within the first central aperture of the indexing plate and fastened to the inboard plate, and
a second axle plate with a diameter less than the diameter of the second central aperture of the outboard plate yet larger than the diameter of the first central aperture of the indexing plate, the second axle plate located within the central aperture of the outboard plate and fastened to the inboard plate,
wherein the indexing plate is compressed between the inboard plate and the second axle plate, so that the indexing plate resists rotating with respect to the axle; and
an indexing pin attached to an outboard plate, the indexing pin sized to fit within any of the plurality of indexing apertures of the indexing plate and aligned to fit in any of the plurality of indexing apertures of the indexing plate,
wherein when the indexing pin is drawn clear of the indexing plate, the outboard plate may rotate relative to the axle plate and indexing plate.

25. The mannequin of claim 23, wherein the second joint of the leg assembly comprises:
an elastomer spring having an orthogonal cross-shaped aperture;
first and second linked U-shaped fasteners within the orthogonal cross-shaped aperture of the elastomer spring, the first U-shaped fastener attached to an outboard plate adjacent to a first end of the elastomer spring, the second U-shaped fastener attached to a femur plate adjacent to a second end of the elastomer spring opposite the first end of the elastomer spring; and
a femur segment attached to the femur plate,
wherein when the femur segment is disturbed from its resting position about a yaw or pitch axis, the elastomer spring compresses, and the compression of the elastomer spring applies a restoring force to the femur segment to return the femur segment to its resting position, and
wherein when the femur segment is disturbed from its resting position about a rotation axis, the first and second U-shaped fasteners distort the orthogonal cross-shaped aperture of the elastomer spring, thereby increasing a restoring force within the elastomer spring to return the femur segment to its resting position.
